(19) United States
(12) Patent Application Publication
(10) Pub. No.: US 2026/0174006 A1
(43) Pub. Date: Jun. 25, 2026

(54) METHODS AND CONTROL SYSTEMS FOR CALCULATING A SIZE OF A PREDEFINED AREA

(71) Applicant: Greenworks (Jiangsu) Co., Ltd, Changzhou (CN)

(72) Inventor: Andre Lundkvist, Habo (SE)

(21) Appl. No.: 19/540,584

(22) Filed: Feb. 14, 2026

Related U.S. Application Data
(63) Continuation of application No. PCT/CN2023/125317, filed on Oct. 19, 2023.

(51) Int. Cl. A01D 34/68; A01D 34/64; A01D 34/66; A01D 34/73; A01D 34/74; A01D 34/82

(52) U.S. Cl. CPC A01D 34/6806; A01D 34/64; A01D 34/66; A01D 34/68; A01D 34/73; A01D 34/74; A01D 34/82; A01D 34/824; A01D 34/828

(57) ABSTRACT

A method performed by a control system for calculating a size of a predefined area is disclosed. A geographic layout of the predefined area is stored in the control system. The method comprises: defining parallel lines across the entire predefined area, wherein the length of each parallel line is equal to or greater than the width of the predefined area in the direction of each parallel line and the distance between each parallel line is equal; processing the parallel lines so that parts of the parallel lines which are outside the predefined area are deleted; calculating a total length of all the processed parallel lines; and calculating the size of the predefined area based on the total length of the processed parallel lines and the distance between each parallel line.

### CROSS REFERENCE TO RELATED APPLICATIONS

The present application is a Continuation Application of PCT Application No. PCT/CN2023/125317 filed on Oct. 19, 2023, the contents of which are incorporated herein by reference in their entirety.

### TECHNICAL FIELD

The present disclosure relates generally to methods and control systems for calculating a size of a predefined area. The present disclosure also relates to lawn mower, computer program and carrier which relate to the methods and controls systems for calculating the size of the predefined area.

### BACKGROUND

When a lawn mower is moving on a predefined working area, there is a need for calculating the size of the predefined area. By calculating the size of the predefined area, the work of the lawn mower can be better planned or arranged.

In prior art, the size of the predefined area can be calculated by generating grids onto the predefined area and adding up the areas of all the grids. However, such method is complicated and requires some calculating capacity.

Therefore, there is a need for a more simple, flexible and economic solution for calculating the size of the predefined area.

### SUMMARY

It is an object of the invention to address at least some of the problems and issues outlined above. It is an object of embodiments of the invention to provide a method for calculating the size of the predefined area in a simple, flexible and economic way. It is possible to achieve the object and possibly others by providing the methods and control systems as defined in the attached claims.

In a first aspect of the invention, a method performed by a control system for calculating a size of a predefined area is disclosed. A geographic layout of the predefined area is stored in the control system, and the method comprises: defining parallel lines across the entire predefined area, wherein the length of each parallel line is equal to or greater than the width of the predefined area in the direction of each parallel line and the distance between each parallel line is equal; processing the parallel lines so that parts of the parallel lines which are outside the predefined area are deleted; calculating a total length of all the processed parallel lines; calculating the size of the predefined area based on the total length of the processed parallel lines and the distance between each parallel line.

According to another embodiment, wherein the calculating of the size of the predefined area further comprises multiplying the total length of the processed parallel lines with the distance between each parallel lines.

According to another embodiment, the distance between each parallel line is predefined or dynamically defined.

According to another embodiment, the angle of the parallel lines in relation to a horizontal line is predefined or dynamically defined.

In a second aspect of the invention, a control system for calculating a size of a predefined area is disclosed. A geographic layout of the predefined area is stored in the control system, the control system comprises a processing circuitry and a memory, the memory containing instructions executable by the processing circuitry, the control system is operative for: defining parallel lines across the entire predefined area, wherein the length of each parallel line is equal to or greater than the width of the predefined area in the direction of each parallel line and the distance between each parallel line is equal; processing the parallel lines so that parts of the parallel lines which are outside the predefined area are deleted; calculating a total length of all the processed parallel lines; calculating the size of the predefined area based on the total length of the processed parallel lines and the distance between each parallel line.

According to another embodiment, the control system is further operative for performing the methods defined above.

According to another embodiment, the control system is arranged in a lawn mower or in a network device.

In a third aspect of the invention, a lawn mower comprising the control system defined above is disclosed, wherein the predefined area is a working area of the lawn mower.

According to another embodiment, the lawn mower is configured based on the calculated size of the working area.

In a fourth aspect of the invention, a computer program is disclosed. The computer program comprises instructions, which, when executed by a processing circuitry of a control system, controlling the control system to calculate a size of a predefined area, causes the control system to perform methods as defined above.

In a fifth aspect of the invention, a carrier containing the computer program defined above is disclosed, wherein the carrier is one of an electronic signal, an optical signal, a radio signal, an electric signal, or a computer readable storage medium.

### BRIEF DESCRIPTION OF DRAWINGS

The invention is now described, by way of example, with reference to the accompanying drawings, in which:

FIG. 1 schematically shows a predefined area with generated lines, according to possible embodiments.

FIG. 2 schematically shows a predefined area with processed lines, according to possible embodiments.

FIG. 3 schematically shows a flow chart of the method for calculating the size of the predefined area, according to possible embodiments.

FIG. 4 schematically shows the control system in detail, according to possible embodiments.

FIG. 5 schematically shows the lawn mower and the control system.

### DETAILED DESCRIPTION

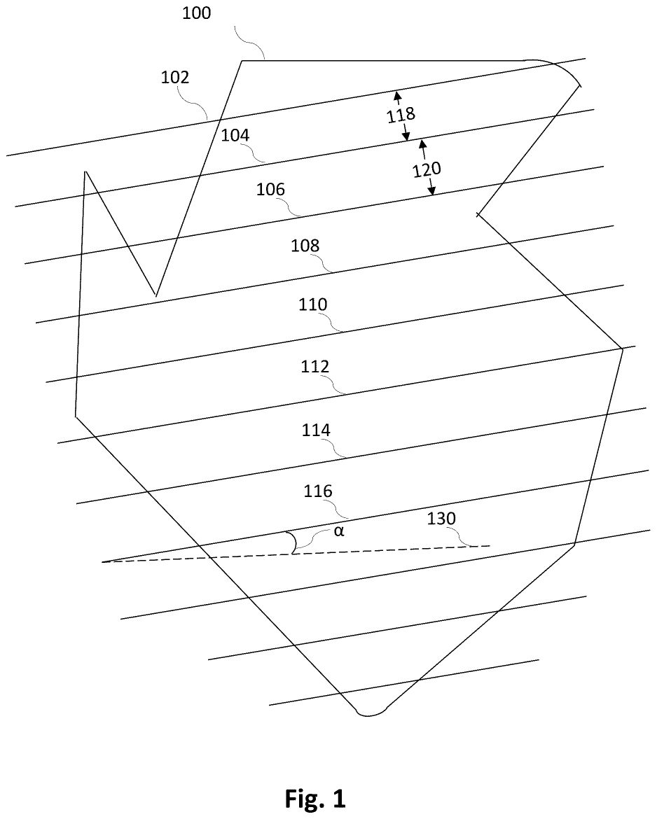

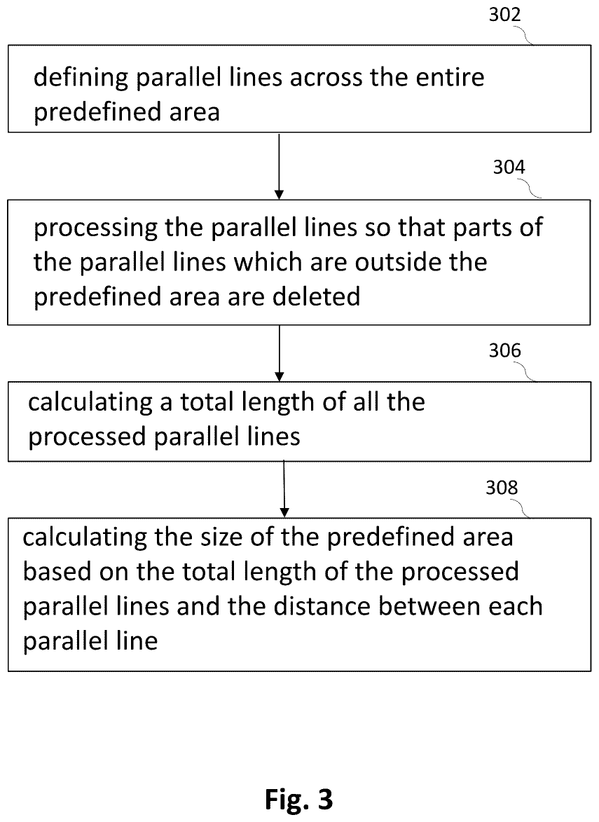

According to one embodiment and referring to FIGS. 1-3, a method performed by a control system 800 for calculating a size of a predefined area 100 is disclosed. A geographic layout of the predefined area 100 is stored in the control system 800. The method comprises defining 302 parallel lines 102, 104, 106, 108, 110, 112, 114, 116 across the entire predefined area 100, wherein the length of each parallel line is equal to or greater than the width of the predefined area 100 in the direction of each parallel line and the distance 118, 120 between each parallel line is equal; processing 304 the parallel lines 102, 104, 106, 108, 110, 112, 114, 116 so that parts of the parallel lines which are outside the predefined area 100 are deleted; calculating 306 a total length of all the processed parallel lines 202, 204, 206, 208, 210, 212, 214, 216, 218; calculating 308 the size of the predefined area 100 based on the total length of the processed parallel lines 202, 204, 206, 208, 210, 212, 214, 216, 218 and the distance 118, 120 between each parallel line.

Referring to FIG. 1, the shape of the predefined area 100 can be irregular. The calculating method is performed by a control system 800 and the geographical layout of the predefined area 100 is stored in the control system 800 for calculation. The calculation is based on the geographical layout of the predefined area 100.

In the step 302, parallel lines 102, 104, 106, 108, 110, 112, 114, 116 are defined across the entire predefined area 100. The length of each parallel line is equal to or greater than the width of the predefined area 100 in the direction of each parallel line, so that it is guaranteed that each parallel line crosses through the whole predefined area 100 in corresponding direction. The distance 118, 120 between each parallel line is equal, so that the predefined area 100 is equally “sliced” by the parallel lines.

In the step 304, the parallel lines 102, 104, 106, 108, 110, 112, 114, 116 are processed so that parts of the parallel lines which are outside the predefined area 100 are deleted, so that processed parallel lines 202, 204, 206, 208, 210, 212, 214, 216, 218 are obtained. By performing this step, the processed parallel lines 202, 204, 206, 208, 210, 212, 214, 216, 218 only cover the entire predefined area 100 and would not go beyond the predefined area 100.

In the step 306, a total length of all the processed parallel lines 202, 204, 206, 208, 210, 212, 214, 216, 218 is calculated. Please note that the reference numbers only schematically refer to some parallel lines. The total length of ALL the processed parallel lines should be calculated. Since the geographical layout of the predefined area 100 is stored in the control system 800, it is applicable to calculate the total length of all the processed parallel lines based on their geographical positions.

In the step 308, the size of the predefined area 100 is calculated based on the total length of the processed parallel lines 202, 204, 206, 208, 210, 212, 214, 216, 218 and the distance 118, 120 between each parallel line.

By this method, the size of the predefined area 100 is simply calculated by using parallel lines across the predefined area 100 and the distance between the parallel lines. The calculation is easy to perform and the requirement for calculating capacity is low.

According to another embodiment, the calculating 308 of the size of the predefined area 100 further comprises multiplying the total length of the processed parallel lines 202, 204, 206, 208, 210, 212, 214, 216, 218 with the distance 118, 120 between each parallel lines.

By this method, the size of the predefined area 100 is simply calculated by multiplying the total length of the processed parallel lines with the distance between the parallel lines. When the number of the parallel lines is decreased and the distance between the parallel lines is increased, the calculation of the size becomes easier but less accurate. When the number of the parallel lines is increased and the distance between the parallel lines is decreased, the calculation of the size becomes more accurate but also more complicated.

According to another embodiment, the distance 118, 120 between each parallel line is predefined or dynamically defined.

By this method, the distance 118, 120 can be statically or dynamically configured. The number of the parallel lines is also statically or dynamically configured accordingly. The accuracy and complexity of the calculation is controlled by configuring the distance 118, 120.

According to another embodiment, the angle α of the parallel lines 102, 104, 106, 108, 110, 112, 114, 116 in relation to a horizontal line 130 is predefined or dynamically defined.

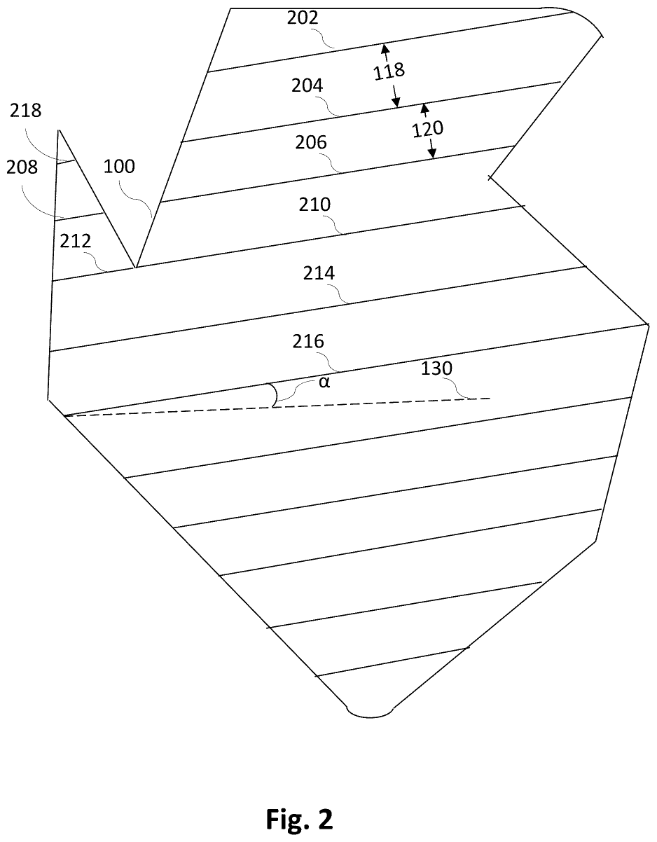

Referring to FIGS. 1 and 2, the angle α is the angle between each parallel line and a horizontal line 130. This angle can be statically or dynamically configured.

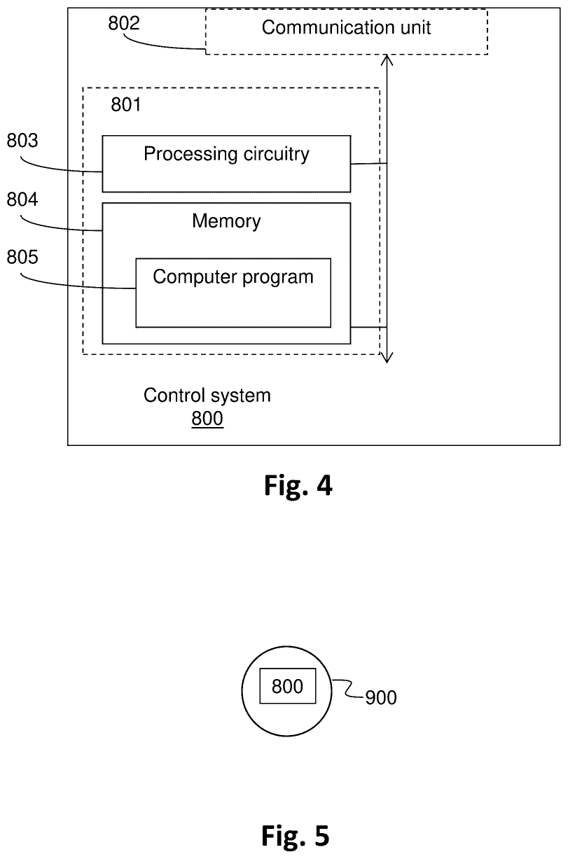

According to another embodiment, referring to FIG. 4, a control system 800 is disclosed. The control system 800 is used for calculating a size of a predefined area 100, wherein a geographic layout of the predefined area 100 is stored in the control system 800, the control system 800 comprises a processing circuitry 803 and a memory 804, the memory 804 containing instructions executable by the processing circuitry 803. The control system 800 is operative for: defining parallel lines 102, 104, 106, 108, 110, 112, 114, 116 across the entire predefined area 100, wherein the length of each parallel line is equal to or greater than the width of the predefined area 100 in the direction of each parallel line and the distance 118, 120 between each parallel line is equal; processing the parallel lines 102, 104, 106, 108, 110, 112, 114, 116 so that parts of the parallel lines which are outside the predefined area 100 are deleted; calculating a total length of all the processed parallel lines 202, 204, 206, 208, 210, 212, 214, 216, 218; and calculating the size of the predefined area 100 based on the total length of the processed parallel lines 202, 204, 206, 208, 210, 212, 214, 216, 218 and the distance 118, 120 between each parallel line.

According to other embodiments, the control system 800 is further operative for performing the methods defined in above embodiments.

According to another embodiment, the control system 800 can be arranged in a lawn mower 900 or in a network device. The network device can be any kind of device which is connected to a network and capable of arranging the control system 800.

According to another embodiment, referring to FIG. 5, a lawn mower 900 comprising the control system 800 is disclosed. The predefined area 100 is a working area of the lawn mower 900. By calculating the size of the working area, the lawn mower 900 can work more efficiently based on the calculated size.

According to another embodiment, the lawn mower 900 is configured based on the calculated size of the working area.

In this embodiment, the configuration of the lawn mower 900 can be based on the calculated size of the working area. For example, the configuration of “compressed cutting” can be based on the calculated size of the working area. The configuration compressed cutting is used for maximising the time for the working area, e.g., a lawn, to be used for other activities rather than mowing. It is also used for limiting the working area for a specific lawn mower model.

In short, in the compressed cutting mode, the lawn mower 900 will mow the lawn efficiently for a maximum of X hours/day, and will spend the rest of the time, i.e., (24-X), at a charging station.

“Compressed cutting” is a feature of the lawn mower 900 that gives the customer max working area capacity, and still leaves the lawn free for some time for other activities like watering or playing.

The mower will cut a complete map as fast as possible according to the schedule and then leave it free to use until next time it is configured to be cut. It should be noted that if the working area exceeds a maximum working area for the model of the lawn mower 900, the lawn mower 900 may stay longer in charging station and the cutting result may not be good. Therefore, it is necessary to obtain the size of the working area when configuring the compressed cutting feature.

According to other embodiments, referring to FIG. 4, the control system 800 may further comprise a communication unit 802, which may be considered to comprise conventional means for wireless communication with other devices, such as a transceiver for wireless transmission and reception of signals. The instructions executable by said processing circuitry 803 may be arranged as a computer program 805 stored e.g. in said memory 804. The processing circuitry 803 and the memory 804 may be arranged in a sub-arrangement 801. The sub-arrangement 801 may be a micro-processor and adequate software and storage therefore, a Programmable Logic Device, PLD, or other electronic component(s)/processing circuit(s) configured to perform the methods mentioned above. The processing circuitry 803 may comprise one or more programmable processor, application-specific integrated circuits, field programmable gate arrays or combinations of these adapted to execute instructions.

The computer program 805 may be arranged such that when its instructions are run in the processing circuitry, they cause the control system 800 to perform the steps described in any of the described embodiments of the control system 800 and its method. The computer program 805 may be carried by a computer program product connectable to the processing circuitry 803. The computer program product may be the memory 804, or at least arranged in the memory. The memory 804 may be realized as for example a RAM (Random-access memory), ROM (Read-Only Memory) or an EEPROM (Electrical Erasable Programmable ROM). In some embodiments, a carrier may contain the computer program 805. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 804. Alternatively, the computer program may be stored on a server or any other entity to which the control system 800 has access via the communication unit 802. The computer program 805 may then be downloaded from the server into the memory 804.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a control system (800) for calculating a size of a predefined area (100), wherein a geographic layout of the predefined area (100) is stored in the control system (800), the method comprises:
defining (302) parallel lines (102, 104, 106, 108, 110, 112, 114, 116) across the entire predefined area (100), wherein the length of each parallel line is equal to or greater than the width of the predefined area (100) in the direction of each parallel line and the distance (118, 120) between each parallel line is equal;
processing (304) the parallel lines (102, 104, 106, 108, 110, 112, 114, 116) so that parts of the parallel lines which are outside the predefined area (100) are deleted;
calculating (306) a total length of all the processed parallel lines (202, 204, 206, 208, 210, 212, 214, 216, 218);
calculating (308) the size of the predefined area (100) based on the total length of the processed parallel lines (202, 204, 206, 208, 210, 212, 214, 216, 218) and the distance (118, 120) between each parallel line.

2. The method as claimed in claim 1, wherein the calculating (308) of the size of the predefined area (100) further comprises multiplying the total length of the processed parallel lines (202, 204, 206, 208, 210, 212, 214, 216, 218) with the distance (118, 120) between each parallel lines.

3. The method as claimed in claim 1, wherein the distance (118, 120) between each parallel line is predefined or dynamically defined.

4. The method as claimed in claim 1, wherein the angle (α) of the parallel lines (102, 104, 106, 108, 110, 112, 114, 116) in relation to a horizontal line (130) is predefined or dynamically defined.

5. A control system (800) for calculating a size of a predefined area (100), wherein a geographic layout of the predefined area (100) is stored in the control system (800), the control system (800 comprises a processing circuitry (803) and a memory (804), the memory (804) containing instructions executable by the processing circuitry (803), the control system (800) is operative for:
defining parallel lines (102, 104, 106, 108, 110, 112, 114, 116) across the entire predefined area (100), wherein the length of each parallel line is equal to or greater than the width of the predefined area (100) in the direction of each parallel line and the distance (118, 120) between each parallel line is equal;
processing the parallel lines (102, 104, 106, 108, 110, 112, 114, 116) so that parts of the parallel lines which are outside the predefined area (100) are deleted;
calculating a total length of all the processed parallel lines (202, 204, 206, 208, 210, 212, 214, 216, 218);
calculating the size of the predefined area (100) based on the total length of the processed parallel lines (202, 204, 206, 208, 210, 212, 214, 216, 218) and the distance (118, 120) between each parallel line.

6. A control system (800) for calculating a size of a predefined area (100), wherein a geographic layout of the predefined area (100) is stored in the control system (800), the control system (800 comprises a processing circuitry (803) and a memory (804), the memory (804) containing instructions executable by the processing circuitry (803), the control system (800) is operative for:
defining parallel lines (102, 104, 106, 108, 110, 112, 114, 116) across the entire predefined area (100), wherein the length of each parallel line is equal to or greater than the width of the predefined area (100) in the direction of each parallel line and the distance (118, 120) between each parallel line is equal;
processing the parallel lines (102, 104, 106, 108, 110, 112, 114, 116) so that parts of the parallel lines which are outside the predefined area (100) are deleted;
calculating a total length of all the processed parallel lines (202, 204, 206, 208, 210, 212, 214, 216, 218);
calculating the size of the predefined area (100) based on the total length of the processed parallel lines (202, 204, 206, 208, 210, 212, 214, 216, 218) and the distance (118, 120) between each parallel line, wherein the control system (800) is further operative for performing the method defined in claim 2.

7. The control system as claimed in claim 5, wherein the control system (800) is arranged in a lawn mower (900) or in a network device.

8. A lawn mower (900) comprising the control system (800) claimed in claim 5, wherein the predefined area (100) is a working area of the lawn mower (900).

9. The lawn mower (900) as claimed in claim 8, wherein the lawn mower (900) is configured based on the calculated size of the working area.

10. A computer program (805) comprising instructions, which, when executed by a processing circuitry (803) of a control system (800), controlling the control system (800) to calculate a size of a predefined area (100), causes the control system (800) to perform the method as claimed in claim 1.

11. A carrier containing the computer program (805) according to claim 10, wherein the carrier is one of an electronic signal, an optical signal, a radio signal, an electric signal, or a computer readable storage medium.
